(19) United States
(12) Patent Application Publication
(10) Pub. No.: US 2013/0297481 A1
(43) Pub. Date: Nov. 7, 2013

(54) PERFORMING FINANCIAL TRADING VIA SOCIAL NETWORKS OR VIA INSTANT MESSAGING SERVICES

(71) Applicant: Johnathan Assia, Savyion (IL)

(72) Inventor: Johnathan Assia, Savyion (IL)

(73) Assignee: eToro Group ltd, Tortola (VG)

(21) Appl. No.: 13/874,493

(22) Filed: May 1, 2013

Related U.S. Application Data
(60) Provisional application No. 61/743,442, filed on May 1, 2012.

(51) Int. Cl. G06Q 40/04; G06Q 50/00

(52) U.S. Cl. CPC G06Q 40/04; G06Q 50/01
USPC 705/37

(57) ABSTRACT

Various embodiments of a method for performing financial trading via a social network, in which a social network and a financial network are both provisioned and linked, after which messages intended for the financial network are posted on the social network. Various embodiments of a method for mirroring financial trading via a social network, in which mirror conditions in a financial network are defined, and then changed, deleted, or supplemented, by messages posted on a social network. Various embodiments of receiving information from multiple sources, and then posting a response on a social network to be read by other users of the social network, a financial network, or other networks. Various embodiments of a method for performing a dialogue on a social network to manage an account pre-existing on financial network, including inquiring about financial status or financial trading via the social network.

### PRIORITY CLAIM

This patent claims priority under 35 U.S.C. §119 to the U.S. provisional patent application Ser. No. 61/743442, filed May 1, 2012, entitled “PERFORMING FINANCIAL TRADING VIA SOCIAL NETWORKS OR VIA INSTAND MESSAGING SERVICES”. The entire contents of this provisional patent application Ser. No. 61/743442 are hereby incorporated by reference.

### BACKGROUND

A social network is an online electronic platform that allows social interactions of various types among users participating in the network. Social networks are used, among other things, for making payments and for transferring funds from one user of the network to another user. Social networks have not been used for the trading of currencies, commodities, securities, and other financial instruments, nor have they been used for the management of accounts related to such trading.

### SUMMARY

Described herein are systems and methods for trading financial instruments over a social network, in which each of a social network and a financial network have been provisioned to accept communication, and the two networks are linked at the time of trading. Described herein also are systems and methods for using a social network to manage a financial account associated with trading of financial instruments. Described herein also are systems and methods for receiving context information and responding to such information over a social network.

One embodiment is a method for performing financial trading via a social network. In one particular form of the embodiment, a user provisions a social network and a financial network to communicate with each other, according to whatever rules or limitations decided by the user. The user then enters a pre-existing account on a social network and a pre-existing account on the financial network, and creates a link between the two networks. The user then sends a message to the social network instructing the social network to post a message telling a financial network to execute a trade of a financial instrument. The financial network reads the message, directly or through the social network acknowledges to the user that the financial network has read the message, and provides an acknowledgement to the user either directly or through the social network that the financial network has received the message. The financial network will then attempt to execute the financial trade. If the financial trade is executed successfully, the financial network with confirm execution to the user, in which confirmation may be direct or through posting a message on the social network which is then read by the user. If the financial trade is not executed successfully, the financial network will notify the user of the rejection of the financial trade, in which notice of rejection may be direct or through posting a message on the social network which is then read by the user.

In embodiments alternative to the embodiment just described, the financial network's receipt of acknowledgement includes also a request for permission to execute the trade requested by the user. The user then grants or denies such permission, where the grant or denial of permission may be sent directly from the user to the financial network or by the user's posting of grant or denial on the social network where the grant or denial is then read by the financial network. One embodiment is a method for mirroring financial trading via a social network. In one particular form of the embodiment, a user creates a mirroring connection on a financial network. The user then receives information from any source of information about one or more financial trades that have been executed by one or more parties, where each such trade is related to the mirroring connection. The source of information may be, but need not be, a financial network. Based on such information, the user selects a financial trade to be executed on the financial network. The user enters a pre-existing account on a social network, and sends a message to the social network instructing to post a message telling a financial network to execute the selected trade of a financial instrument. The financial network reads the message, acknowledges receipt of message to the user either directly or through a posting to the social network, attempts to execute the trade, and then directly or indirectly through the social network confirms execution if execution was successful or notifies of rejection if execution was unsuccessful.

In alternative embodiments to the mirroring financial trading just described, the financial network's receipt of acknowledgement includes also a request for permission to execute the trade requested by the user. The user then grants or denies such permission, where the grant or denial of permission may be sent directly from the user to the financial network or by the user's posting of grant or denial on the social network where the grant or denial is then read by the financial network.

In alternative embodiments to the mirroring financial trade described above, the user does not request to execute a trade but requests rather to create or change one or more of the mirror conditions. In some embodiments, the financial network directly or indirectly through the social network acknowledges the request, tries to execute the request, and then directly or indirectly through the social network confirms successful execution of the request or notifies of rejection where the request was not fulfilled. In some embodiments, the acknowledgement to the user includes a request for permission to create or change the mirror condition, and the financial network will execute the new or changed mirror condition only after it has received permission form the user.

In alternative embodiments to the method for mirroring financial trading described above, the user does not make a decision to trade a financial instrument in response to new information received by the user. Rather, the user defines the mirroring connection such that when one or more specified trades are made by one or more specified other parties, the financial network on which the mirroring connection has been made will automatically execute one or more trades in accordance with the definitions of the mirroring connection. In this alternative embodiment, information is posted to the social network. The information may be posted by the user, or by any third party whether human or machine. The financial network reads the post. According to the definitions of the mirroring connection, the financial network may immediately execute one or more trades and then inform the user of the trades. Alternatively the financial network may request of the user permission to trade, where such request is made directly to the user or by posting a message to the social network that is read by the user. If permission is then received from the user, either directly to the financial network or via the social network, the financial network will execute the trades, and confirm execution to the user either directly to the user or by posting a message to the social network that is read by the user.

One embodiment is a method for responding to context information via a social network. In one particular form of the embodiment, context information is received by the user from any source. In alternative embodiments, source of information may be a social network, or a financial network, or some other source. In response to receiving such information, the user posts a message to a social network. The message may indicate that an action is to be taken by a financial network, or may call for some other action, or may simply be a posting of information. In alternative embodiments, the message is not posted specifically by the user, but rather the message is posted automatically after the information is posted on the social network. In alternative embodiments, messages posted to the social network in response to information received are collected by a third party, and the third party reviews such messages to determine information about either the messages themselves or the users who posted the messages. One embodiment is performing a dialogue via a social network to manage an account pre-existing on a financial network. In one particular form of the embodiment, a user enters a pre-existing social network account and a pre-existing financial network account, where the social and financial networks have already been provisioned to communicate with each other. The user sends a message to be posted by the social network that asks a question of a financial network where the user has an account. The question concerns some aspect of the status of such financial account. The message is read by the financial network at which the user has an account. In one alternative embodiment, the financial network automatically finds the answer to the question, and sends the answer to the user either directly or by posting the answer on the social network, where it will be read by the user. In another alternative embodiment, the financial network asks the user for permission to answer the question, where the financial network may ask the user directly or by posting its request to a social network to be read by the user. In this alternative embodiment, the user grants permission, either directly to the financial network or by posting a message on the social network that is read by the financial network. The financial network then provides the answer, either directly to the user or by posting the answer on the social network for the user to read.

In all of the embodiments described herein, the user communicates to the social network with messages that have been constructed according to a particular template. Such messages are called “structured text messages”, or “STMs” for short. If the structure for the messages is provided for multiple users of the social network, then the message is considered to be an ordinary STM, called simply an “STM”. However, the user may redefine the standard structure so that the structure of messages have been customized for that one user. In this case, the user's messages are “personalized structured text messages”, or “p-STMs” for short. In alternative embodiments, a p-STM is made available for a group of two or more users on a social network, but is not available for all the users of the social network.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1 illustrates one embodiment of a system for linking a social network and a financial network.

FIG. 2 illustrates one embodiment of a system for linking a social network and a financial network, and for allowing informational content to be conveyed directly or indirectly to a user.

FIG. 3 illustrates a flow diagram describing one method for financial trading via a social network.

FIG. 4 illustrates a flow diagram describing one method for financial trading via a social network, in which the actions illustrated are executed solely by the social network.

FIG. 5 illustrates a flow diagram describing one method for financial trading via a social network, in which the actions illustrated are executed solely by a financial network.

FIG. 6 illustrates a flow diagram describing one method for financial trading via a social network, including a contextual reference.

FIG. 7 illustrates a flow diagram describing one method for mirroring financial trading.

FIG. 8 illustrates a flow diagram describing one method for mirroring trading, in which the actions illustrated are executed solely by a financial network.

FIG. 9 illustrates a flow diagram describing one method of dialogue for account management.

FIG. 10 illustrates a flow diagram describing one method of dialogue for account management, in which the actions illustrated are executed solely by a financial network.

FIG. 11 illustrates a flow diagram describing a method by which a user may communicate structured text messages to and from social and financial networks.

FIG. 12 illustrates a flow diagram describing a method by which a user may communicate personalized structured text messages to and from social and financial networks.

### DETAILED DESCRIPTION

Various embodiments describe ways in which users interact and perform actions via a social network. In some embodiments, a user executes financial trades on a financial network via a social network. In some embodiments, financial trades are executed according to one or more mirror conditions, via a social network. In some embodiments, there is a dialogue between a user and a financial network, executed via a social network. In some embodiments, there is context transference, as a result of which the user posts a message on a social network, where such message may or may not relate to a financial trade. In any of the foregoing embodiments, the messages sent by the user may be in a structured text message or “STM” format, without any customization, or the message may be sent in an STM format that has been customized by the user or some other person for that user or for a small group of defined users, where such a customized format is a personalized STM or “p-STM”.

A number of terms are used in the presentation of embodiments, among which are the following:

“Verification” is a message conveyed from a user to a financial network that grants permission to the financial network to perform actions or a specific action. The message may be conveyed directly from the user to the financial network, or by posting the message on a social network where it is then read by the financial network. The act of delivering such a message is “verifying”.

“User” is, in some embodiments, a person who wishes to execute a financial trade, and who accesses a social network and/or financial network to execute the trade. In other embodiments, “user” is a person who receives information from source and, as a result of such information, posts a message to a social network even if the message does not relate directly to a financial trade, or performs an action on a social network.

“Instruction page” is the page or message sent to a user that is used to create the link between a social network and a financial network. The user may receive this from either the social network or the financial network, and will use the instruction page to communicate with both the social network and the financial network.

“Context” is one or more circumstances related to a message received from a third party. Examples of such circumstances include the identity of the third party, the day or time such message is created, the place at which the message is received by the user, and any choices offered the user for selection, and in general any information a user was exposed prior or at the time the message was received.

“Context transference” is the sending of a context together with a message from a network to a user. The network may be a social network, a financial network, or any other network that communicates information electronically.

“GUI” is an acronym for “graphical user interface”, and is the interface between a user on the one hand, and a pre-programmed non-changeable program on the other hand. The GUI may give the user options for selection, but does not allow free text response or response customized to or from the user. A message sent through a GUI has not been personalized, and is a structured text message or “STM” for short.

“API” is an acronym for “application programming interface”, and is the interface between a person and a network to which the message will be sent. The API is the interface used by a person to define a message format. If API is used by a programmer or other professional to design a message format that will me be used by multiple users of a network, then the resulting format is used for structured text messages or “STMs”. If the API is used by a user to create a format only for that user or for a defined group of users, then the resulting format is used for personalized structured text messages or “p-STM”. An API may be delivered to the user as an ordinary electronic message, or as an instant message on a social network.

“Structured text message”, or “STM”, is a digital message consisting of characters, numbers, and/or images, which has been parsed in such a way that different locations in the message serve different purposes, and specific symbols of characters, numbers, and/or images, communicate different messages within the STM, where all of the locations and symbols have been defined prior to generation of the message. A “personalized STM” is an STM that has been customized for the particular needs of a particular user or for a defined group of users.

“Social network”, or “SN”, is an electronic network joined by people for the purposes of communicating with other people in accordance with the rules for communication defined by the network. Examples of social networks include Facebook®, Google Plus®, and Twitter®, but there are many more, including without limitation social networks which have been customized for particular audiences. As used herein, “social network” includes also instant messaging platforms, such as Digsby, WhatsApp Messenger, and GTalk. Typically the user will enter the social network by a website dedicated to that social network. A social network is comprised of both hardware and software, including hardware to store, process, and transfer information, as well as instructions in the form of software. The hardware may be general purpose hardware, or special purpose adapted specifically to the needs of the network. The software is customized for the needs of the network.

“Financial trade” is a purchase or sale of any financial instrument, where the purchase or sale is performed in accordance with an electronic command. The command may be sent by a user, or may be generated automatically by a network in accordance with pre-defined rules or conditions.

“Financial instrument” is any currency, stock, real estate investment trust, or any other financial security, or any commodity.

“Financial network” or “FN” is a network used by a user to execute a financial trade. Typically the user will enter the financial network by a website dedicated to that financial network. A financial network is comprised of both hardware and software, including hardware to store, process, and transfer information, as well as instructions in the form of software. The hardware may be general purpose hardware, or special purpose adapted specifically to the needs of the network. The software is customized for the needs of the network.

“Mirroring financial trading” is a technique executed by a user to execute one or more financial trades in response to information received by the user from financial trades executed by third parties. Mirror financial trading is executed in according with mirroring conditions defined by a user, and entered by the user into a financial network.

“Mirror conditions” are conditions that the user has defined and placed into a financial network, which state the circumstances under which a financial trade is to be made on the user's behalf. Virtually any conditions may be made mirror conditions by a user. For example, the user may state every trade by a certain person who is a member of the financial network shall be matched exactly by financial trades for the user. Or the user may match financial trades of such a member, but in percentage terms other than 100%, or only according to some ceiling amount, or not less than some floor amount, or excluding some specific financial instruments, or only in accordance with some limit or stop-loss order. Any such conditions may also be applied to not one, but rather multiple members of the financial network, and in any percentages or amounts allocated among financial trades of the various members. Mirror conditions may also be rules for making a financial trade as a result of an action a user performs on a social network. For example, a user may set rules that state that when a specific user uploads an image to a social network buy one share of a certain security in the financial network.

“Dialogue” herein is a back and forth discussion between a user and a financial network in which the user asks a question and the financial network answers. The user may ask whether a certain financial trade was executed, or what the current is current account balance, or what is the current mix of various financial instruments, or for a history of an account, or any other thing that related to financial trading or to information about the user that is held by or can be generated by the financial network.

“Provisioning” is the process by which a network is prepared to communicate with another network. In some embodiments, it includes preparing a social network to communicate with a financial network, and preparing also the same financial network to communicate with the same social network. In these embodiments, the order of provisioning is not relevant, so that either the social network or the financial network may be provisioned first. Provisioning may be executed by a user directly, or may be executed by a machine, acting in accordance with instructions of a user. Provisioning is not the same thing as a link, but is rather a prerequisite to a link. Provisioning may occur once for the communicating social and financial networks, and this provisioning may support any number of links between the social network and the financial network, unless and until such time as the terms of the provisioning are changed. The rules for a p-STM are initially defined by the user during provisioning of a network. For each of the social network and the financial network, provisioning is executed on the network's hardware interacting with and using the software related to that network.

“Link” is a communicative connection between a social network and a financial network at a particular point in time. In order for there to be a link, each of the two networks must be operational at the time of the link, a user must have entered the networks and remain active on the networks at the time of link, and the two networks must have been provisioned at some time in the past to communicate with one another. In order for a user to enter a network, the user must have an account on the network, which may have been created at a time distant from creation of the link, or which may be created immediately before the link. For each of the social network and the financial network, the link is executed on the network's hardware interacting with and using the software related to that network. The form used by the user to execute a link between a social network and a financial network is the instruction page.

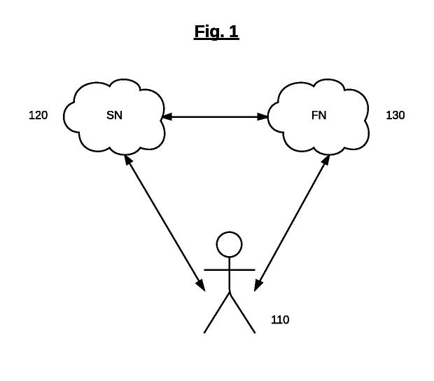

FIG. 1 illustrates one embodiment of a system for linking a social network and a financial network. In FIG. 1, a person 110 is in communicative contact with both a social network SN 120 and a financial network FN 130. Further, the social network 120 and the financial network 130 are also in communicative contact with each other. The communication arrows between any two of the elements in FIG. 1 are two-way, indicating that messages are sent and received between each pair of elements. Further, as more fully described herein, some communications may be indirect, such as from person 110 to financial network 130 but not directly, rather via social network 120. Similarly, communication between person 110 and social network 120 may be via financial network 130 rather than direct. The system illustrated in FIG. 1 utilizes the hardware and software of the social network 120, the hardware and software of the financial network 130, and user terminal associated with user 110.

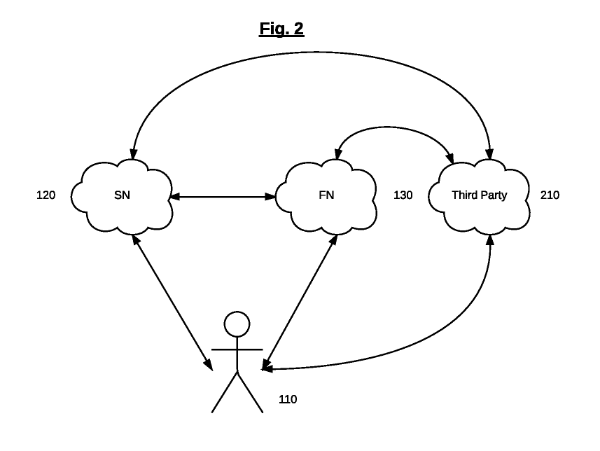

FIG. 2 illustrates one embodiment of a system for linking a social network and a financial network, and for allowing informational content to be conveyed directly or indirectly to a user. The elements person 110, social network 120, and financial network 130 in FIG. 2 function as they do in FIG. 1. However, FIG. 2 adds a third party 210 as a source of information. Such information from 210 may be, for example context information, but the information is not limited to context information. FIG. 2 shows a direct and two-way link between person 110 and third party 210, indicating that messages may be sent first from the third party to the person 110 as in the case, for example, of information known to be of interest to person 110, or messages may be sent from person 110 to third party 210 as in the case of, for example, inquiries by person 110 whose answers are not available on social network 110 or financial network 120. Further, there is a one-way link from third party 210 to social network 120 indicating that messages may be fed from the third party 210 to the social network, but the third party 210 is a source of information that does not read or pull information from social network 120. Similarly, messages may be fed from the third party 210 to the financial network 130, but the third party 210 is a source of information that does not read or pull information form financial network 130. The system illustrated in FIG. 2 utilizes the hardware and software of the social network 120, the hardware and software of the financial network 130, user terminal associated with user 110, and the hardware and software used by the third party 210 to communicate with the user 120, the social network, and the financial network 130.

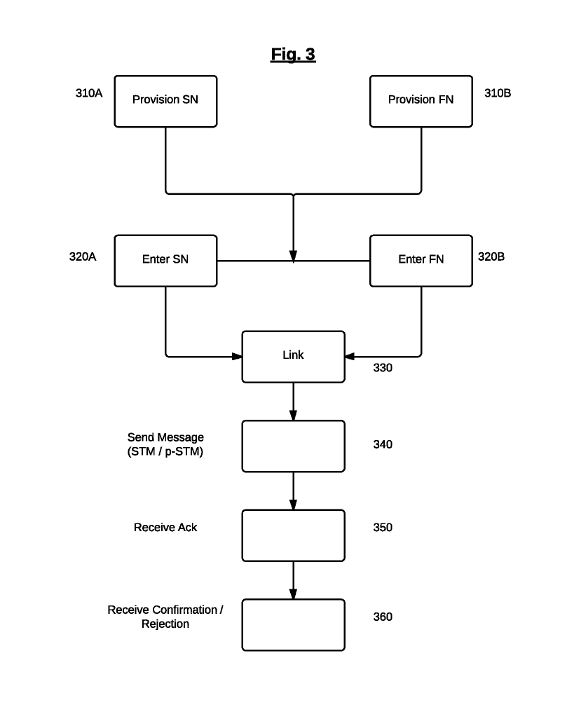

FIG. 3 illustrates a flow diagram describing one method for financial trading via a social network. In order for such trading to occur, the networks must be provisioned, 310A for the social network and 310B for the financial network, to communicate with one another. If this is not done, the method illustrated in FIG. 3 will not function. Further, the provisioning of the two networks, meaning the preparation of the networks to communicate with each other, must occur before a communication link 330 can be made between the networks. Provisioning 310A and 310B is typically done by a user for himself or herself, but it may also be done by a machine or by another person acting on behalf of the user. Despite letters 310A and 310B, provisioning may be done with either the social network first or the financial network first. When a user decides to financially trade via a social network, the user enters the social network 320A and the financial network 320B, so that the user is on both networks at the same time, although entry may be either to the social network first or to the financial network first. A link is now created 330 between the two networks, which allows the networks to communicate, and which in particular allows the financial network to read postings on the social network and to place postings on the social network. The user sends a message for financial trading 340 to the social network, where such message may be in either STM or p-STM format. The user then receives and acknowledgement 350 from the financial network that the user's request has been received by the financial network. This may in the form of a message sent directly from the financial network to the user, or by the financial network's posting of the acknowledgement on the social network which is then read by the user. After the financial network attempts to execute the financial trade in accordance with the message of the user, the financial network will either confirm execution or indicate that execution has been rejected 360. The message of confirmation or rejection may be sent directly from the financial network to the user, or by the financial network's posting of the confirmation or rejection on the social network which is then read by the user.

In one embodiment, financial trading is performed via a social network. In one particular form of the embodiment, a user provisions a social network and a financial network to communicate with each other, according to whatever rules or limitations decided by the user. The user then enters a pre-existing account on a social network and a pre-existing account on the financial network, and creates a link between the two networks. The user then sends a message to the social network instructing the social network to post a message telling a financial network to execute a trade of a financial instrument. The financial network reads the message, directly or through the social network acknowledges to the user that the financial network has read the message, and provides an acknowledgement to the user either directly or through the social network that the financial network has received the message. The financial network will then attempt to execute the financial trade. If the financial trade is executed successfully, the financial network with confirm execution to the user, in which confirmation may be direct or through posting a message on the social network which is then read by the user. If the financial trade is not executed successfully, the financial network will notify the user of the rejection of the financial trade, in which notice of rejection may be direct or through posting a message on the social network which is then read by the user.

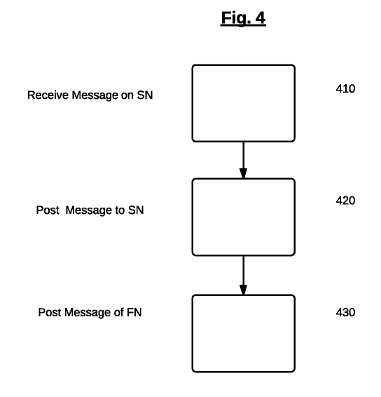

FIG. 4 illustrates a flow diagram describing one method for financial trading via a social network, in which the actions illustrated are executed solely by the social network. FIG. 4 correlates with FIG. 3, but here from the perspective of the social network after the link has been established between the social network and the financial network. The user's message is received by the social network 410, and then posted 420. It will be read by the financial network, which may then post a message on the social network 430, such message being either an acknowledgement that the financial network has read the user's message, or a confirmation or rejection of execution of the financial trade requested by the user. It is possible that the financial rejection will post on the social network 430 both the acknowledgement of user message and the confirmation or rejection of execution.

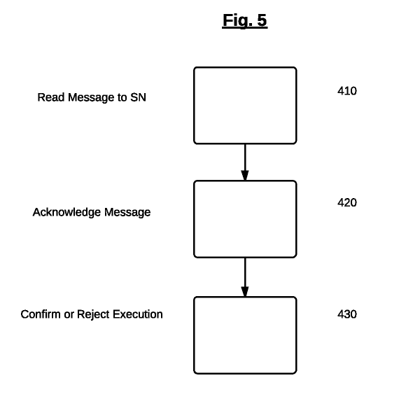

FIG. 5 illustrates a flow diagram describing one method for financial trading via a social network, in which the actions illustrated are executed solely by a financial network. FIG. 5 correlates with FIG. 3, but here from the perspective of the financial network after the link has been established between the social network and the financial network. The user's message that was posted on the social network is read by the financial network 510. The financial network then sends an acknowledgement to the user 520 which may be sent directly or by posting onto the social network to be read by the user. After the network tries to execute the requested financial trade, the financial network will send a confirmation or rejection to the user 530, which may be sent directly or by posting onto the social network to be read by the user.

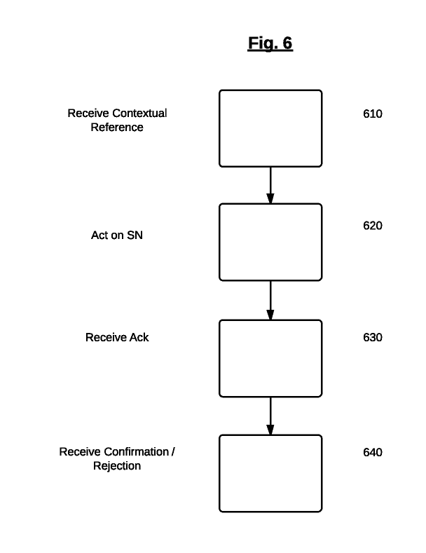

FIG. 6 illustrates a flow diagram describing one method for financial trading via a social network, including a contextual reference. The information in the contextual reference may be financial information, but may also be something else. A contextual reference made by some source of information is received 610 by the user, who then acts on the social network 620, which may include any number of options, such as, for example, requesting execution of a financial trade, posting information, posing a question, changing one of the mirror conditions, or any other action that may be performed on a social network. If the act on the SN 620 is a message for action from a network, such as a financial network, the user will receive acknowledgement 630 that the user's message has been read on the social network, where such acknowledgement may be sent directly to the user or via a posting on the social network to be read by the user. Similarly, if the act on the SN 620 is a message for action from a network, such as a financial network, the user will receive confirmation or rejection of execution 630, which may be sent directly to the user or via a posting on the social network to be read by the user. The action could call for a financial trade, to change a mirror condition, to change a p-STM format, to establish a standing order to receive a certain kind of information, or any other action that may be executed by network for a user, and in general, if the act on the SN 620 is impacts a rule or set of rules to act on the FN, the user will receive acknowledgment 630 that the user's action has been read on the social network, and will then receive a confirmation or rejection of execution of such rule 640.

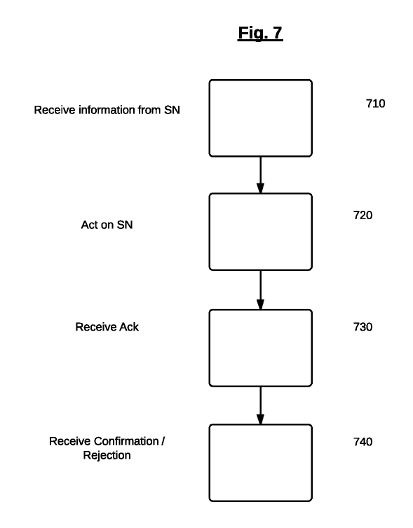

FIG. 7 illustrates a flow diagram describing one method for mirroring financial trading. The user receives information from any source that has been posted on the social network 710. On the basis of that information, the user takes an action on the social network 720. The user may take any of a variety of actions. For example, the user may change a mirror condition that was already established on a financial network. Alternatively, if a mirroring condition was not previously established, but the financial network has been provisioned to accept the creation of mirror conditions, the user may in 720 create mirror conditions for financial trades. Or the user may post some information in 720 to be read by members of the social network. Or the user may ask a question, and post the question on the social network in 720. The user's message posted to social network, whether to create a mirror condition, change a mirror condition, post information, ask a question, or other, may then be read by the financial network, or by another user of the social network, or by some other party. If the message is intended for the financial network, the FN will read the message, then acknowledge such message 730 either directly or by posting the acknowledgement to the social network to be read by the user. In such case, after the financial network has attempted to create or change the mirror condition as requested by the user, the financial network will send notice of confirmation or rejection either directly or through posting on the social network and the user will receive such notice 740 either directly or by reading the notice posted on the social network. The creation or change of a mirror condition is executed via user instructions defined in an instruction page sent to the user.

In one embodiment, mirroring financial trading is executed via a social network.

In one particular form of the embodiment, a user creates a mirroring connection on a financial network. The user then receives information from any source of information about one or more financial trades that have been executed by one or more parties, where each such trade is related to the mirroring connection. The source of information may be, but need not be, a financial network. Based on such information, the user selects a financial trade to be executed on the financial network. The user enters a pre-existing account on a social network, and sends a message to the social network instructing to post a message telling a financial network to execute the selected trade of a financial instrument. The financial network reads the message, acknowledges receipt of message to the user either directly or through a posting to the social network, attempts to execute the trade, and then directly or indirectly through the social network confirms execution if execution was successful or notifies of rejection if execution was unsuccessful.

In some alternatives embodiments to the mirror trading embodiment just described, the message to the social network that affects the mirror condition of an account on a financial network is to add a new mirror condition to the account. In other alternative embodiments, the message to the social network that affects the mirror condition of an account on a financial network is to delete a mirror condition from the account. In other alternative embodiments, the message to the social network that affects the mirror condition of an account on a financial network is to change a pre-existing mirror conditions associated with the account.

In one embodiment, a user responds to context information via a social network. In one particular form of the embodiment, context information is received by the user from any source. In alternative embodiments, source of information may be a social network, or a financial network, or some other source. In response to receiving such information, the user posts a message to a social network. The message may indicate that an action is to be taken by a financial network, or may call for some other action, or may simply be a posting of information. In alternative embodiments, the message is not posted specifically by the user, but rather the message is posted automatically after the information is posted on the social network. In alternative embodiments, messages posted to the social network in response to information received are collected by a third party, and the third party reviews such messages to determine information about either the messages themselves or the users who posted the messages.

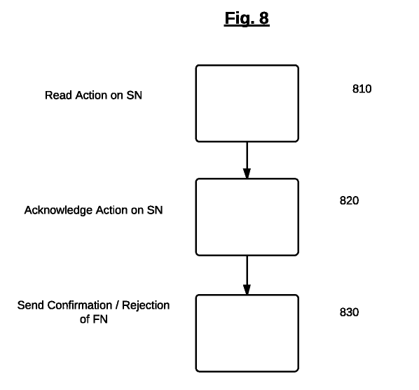

FIG. 8 illustrates a flow diagram describing one method for mirroring trading, in which the actions illustrated are executed solely by a financial network. In 810, the financial network reads the user's message to create or change a mirror condition. In 820, the financial network acknowledges receiving such message, where the acknowledgement may be sent directly to the user or posted on the social network to be read by the user. The financial network attempts to execute the user's message regarding the mirror condition. If the financial network succeeds, then in 840 the financial network communicates confirmation of execution, either directly to the user or by posting the notice on the social network to be read by the user. If the network does not succeed in executing the user's message, then the network communicates notice of rejection, either directly to the user or by posting the notice on the social network to be read by the user.

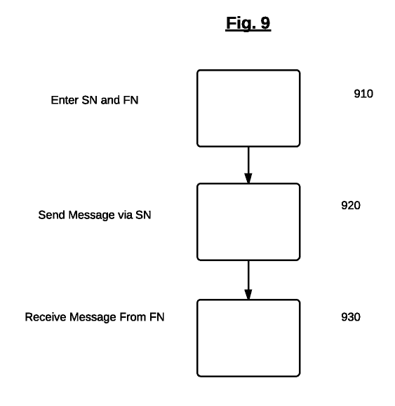

FIG. 9 illustrates a flow diagram describing one method of dialogue for account management. In 910, the user enters a social network and a financial network, which have been previously provisioned to communicate with one another. The user then sends a message to the SN 920, requesting information about an account on the financial network or about a trade executed by the financial network. The financial network will read the posted message, formulate an answer, and send the answer to the user either directly or via the social network, such that the user receives the answer from the financial network 930 either directly or by reading the message posted on the financial network.

In one embodiment, a dialogue via a social network is performed to manage an account pre-existing on a financial network. In one particular form of the embodiment, a user enters a pre-existing social network account and a pre-existing financial network account, where the social and financial networks have already been provisioned to communicate with each other. The user sends a message to be posted by the social network that asks a question of a financial network where the user has an account. The question concerns some aspect of the status of such financial account. The message is read by the financial network at which the user has an account. In one alternative embodiment, the financial network automatically finds the answer to the question, and sends the answer to the user either directly or by posting the answer on the social network, where it will be read by the user. In another alternative embodiment, the financial network asks the user for permission to answer the question, where the financial network may ask the user directly or by posting its request to a social network to be read by the user. In this alternative embodiment, the user grants permission, either directly to the financial network or by posting a message on the social network that is read by the financial network. The financial network then provides the answer, either directly to the user or by posting the answer on the social network for the user to read.

In some alternative embodiments to the embodiment for dialogue with a financial network via a social network as just described, the request for information from the financial network is a request for information about an account pre-existing on the financial network. In other alternative embodiments, the request for information is a request for information about a financial trade executed by the financial network.

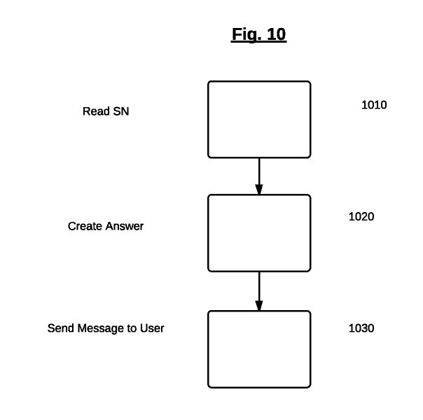

FIG. 10 illustrates a flow diagram describing one method of dialogue for account management, in which the actions illustrated are executed solely by a financial network. In 1010, a financial network that has been linked with a social network reads the social network and finds a message from a user of the financial network asking a question about a trade or an account. In 1020, the financial network formulates the answer to the question. In 1030, the financial network sends the answer to the user, which may be done directly from the financial network to the user or by posting the answer on the social network to be read by the user.

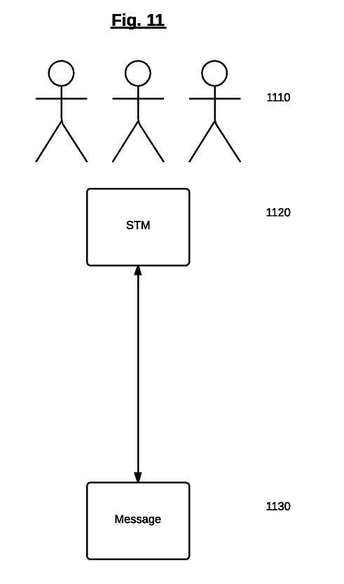

FIG. 11 illustrates a flow diagram describing a method by which a user may communicate structured text messages to and from social and financial networks. In 1110, users seek to communicate a message to a social network. Such message may terminate with posting on the social network, or may be intended by the user to be read and acted upon by a financial network, or may be intended by a user to be read by a non-financial network for purposes of providing information or causing some action to occur. The users may not write free text to a social network, but rather must structure the message specifically to be understood by the social network, in which particular letters, symbols, numbers, or pictures have specific meanings, and the orders of characters may also have specific meanings. In other words, the users will format their messages as structured text messages 1120, which will then be received b y the social network 1130 in a format that can be understood by the network. As simply one of very many examples, a structured text message to a social network might be $@FN1buy$EUR/USDunits100price1.4312. This is the structured message for $=a financial order will appear, @FN1=this order is for financial network 1, buy $EUR/USD=buy euros with dollars, units 100=buy 100 euros, and price 1.4312=price is $1.4312/Euro. In this example, both the specific symbols and the order of symbols create meaning as part of the structure. The STM is the GUI by which the user communicates to and from the social network. The use of STMs by a user to communicate with a social network may apply to any of the embodiments discussed herein. The connections between the users 1110 and the message 1130 is two-way, because the format is STM whether the message is sent to or from the user.

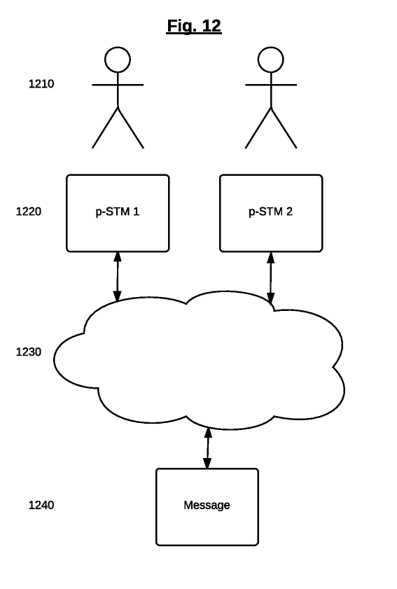

FIG. 12 illustrates a flow diagram describing a method by which a user may communicate personalized structured text messages to and from social and financial networks. In 1210, one or more individual users seek to communicate a message to a social network. Each user wishes to have his or her own message structure. Each user has previously defined a personalized structure 1220, p-STM 1 for one user and p-STM 2 for the other user. Alternatively, each user may define a personalized STM on the fly, which is to say immediately before sending the message. After the message has been structured as a p-STM, it will be received by a social network 1240, interpreted and understood. In some embodiments, not shown in FIG. 12, each p-STM is sent directly to a social network which has been previously provisioned to understand this message, translate it from p-STM to STM, and post it on the social network as an STM message. In other embodiments, shown in FIG. 12, each p-STM is sent to a translator engine 1230 that translates the format of the p-STM into STM format to be read and posted by the social network. A translator engine may be a piece of hardware separate from the hardware of the social network, or may be a software utility operating on hardware of the social network, or may be configured in any other way such that the message is ultimately received by the social network in STM format. The connections between the users 1210 and the message 1240 is two-way, because once the p-STM format has been defined, the format of communication is p-STM whether the message is sent to or from the user.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/ cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A method for a user to perform financial trading via a social network, comprising:
provisioning a social network and a financial work to communicate with one another;
entering into both the social network and the financial network;
creating a link between the social network and the financial network;
sending a message to the social network to execute a financial trade;
receiving acknowledgement from the financial network that this message has been received by the financial network; and
receiving from the financial network confirmation that the financial trade has been executed or notice that execution of the financial trade has been rejected.

2. A method for mirroring financial trading via a social network, comprising:
receiving information that has been posted on a social network;
posting a message to the social network that affects the mirror conditions of an account on a financial network;
receiving acknowledgement from the financial network that the message has been received by the financial network;
receiving confirmation from the financial network that change in mirror conditions has been executed or notice that execution of the change in mirror conditions has been rejected.

3. The method of claim 2, in which the message to the social network that affects the mirror condition of an account on a financial network is to add new mirror condition to the account.

4. The method of claim 2, in which the message to the social network that affects the mirror condition of an account on a financial network is to change a pre-existing mirror condition associated with the account.

5. A method for performing a dialogue on a social network to manage an account pre-existing on financial network, comprising:
entering a social network and a financial network which have been previously provisioned to communicate with each other;
sending a message to the social network requesting information from the financial network; and
receiving an answer to the request from the social network.

6. The method of claim 5, in which the request for information from the financial network is a request for information about an account pre-existing on the financial network.

7. The method of claim 5, in which the request for information from the financial network is a request for information about a financial trade executed by the financial network.
